(19) United States
(12) Patent Application Publication
(10) Pub. No.: US 2018/0020624 A1
(43) Pub. Date: Jan. 25, 2018

(54) PACKAGES FOR LIVING, EDIBLE PLANTS

(71) Applicant: Bryan Vande Vrede, Belvidere, NJ (US)

(72) Inventor: Bryan Vande Vrede, Belvidere, NJ (US)

(21) Appl. No.: 15/658,591

(22) Filed: Jul. 25, 2017

Related U.S. Application Data
(60) Provisional application No. 62/366,242, filed on Jul. 25, 2016.

(51) Int. Cl. A01G 9/08; B65D 85/52; A01G 9/02

(52) U.S. Cl. CPC A01G 9/088; A01G 9/02; B65D 85/52

(57) ABSTRACT

A package for a living, edible plant includes a tray having a bottom wall and four side walls defining an open, upper end of said tray, and a living, edible plant being having leaves that extend above the open, upper end of said tray. The package has a flexible outer container having a bottom panel extending along a closed lower end of the flexible outer container and side panels extending upwardly from the bottom panel toward an open upper end of the flexible outer container. The tray and the plant are disposed inside the flexible outer container so that the bottom wall of the tray reinforces the bottom panel of the flexible outer container and the side walls of the tray oppose the side panels of the flexible outer container. The upper ends of the side panels of the flexible outer container extend above upper ends of the four side walls of the tray. The upper ends of the leaves extend above the upper ends of the side panels of the flexible outer container and the upper ends of the side panels of the flexible outer container engage the leaves for tucking the leaves inwardly inside the flexible outer container.

### CROSS-REFERENCE TO RELATED APPLICATIONS

The present patent application claims benefit of U.S. Provisional Application Ser. No. 62/366,242, filed Jul. 25, 2016, the disclosure of which is hereby incorporated by reference herein.

### BACKGROUND OF THE INVENTION

### Field of the Invention

The present patent application is generally related to the botanical arts and is more particularly related to packages for living, edible plants.

### SUMMARY OF THE INVENTION

In one embodiment, a package for a living, edible plant preferably includes a tray having a bottom wall and four side walls extending upwardly from the bottom wall to define an open, upper end of the tray, and a living, edible plant potted in soil in the tray, the plant including leaves that extend above the open, upper end of the tray and outside an outer perimeter of the tray.

In one embodiment, the package includes a flexible outer container having a bottom panel extending along a closed lower end of the flexible outer container and side panels extending upwardly from the bottom panel toward an open upper end of the flexible outer container. In one embodiment, the tray and the living, edible plant are disposed inside the flexible outer container so that the bottom wall of the tray reinforces the bottom panel of the flexible outer container and the side walls of the tray oppose the side panels of the flexible outer container.

In one embodiment, the tray is more rigid than the bottom panel and the side panels of the flexible outer container. In one embodiment, the upper ends of the side panels of the flexible outer container extend above upper ends of the four side walls of the tray. In one embodiment, the upper ends of the leaves extend above the upper ends of the side panels of the flexible outer container. In one embodiment, the upper ends of the side panels of the flexible outer container engage the leaves for tucking the leaves inwardly inside the flexible outer container.

In one embodiment, a first handle is attached to a first one of the side panels of the flexible outer container, and a second handle attached to a second one of the side panels of the flexible outer container.

In one embodiment, the flexible outer container is transparent.

In one embodiment, the tray has a length of about 6-7 inches, a width of about 4-5 inches and a height of about 2 inches.

In one embodiment, the flexible outer container has a length of about 7-9 inches, a width of about 5-7 inches and a height of about 7 inches.

In one embodiment, prior to being disposed inside the flexible outer container, the plant has a length of about 12-14 inches, a width of about 8-9 inches, and a height of about 8-10 inches.

In one embodiment, the plant includes two or more different types of leaves for two or more different types of lettuce. In one embodiment, the plant includes five or more different types of leaves for five or more different types of lettuce. The five or more different types of lettuce may include green leaf lettuce, red leaf lettuce, red oak leaf lettuce, Bibb lettuce, green oak leaf lettuce, Jericho lettuce, red Romaine lettuce seeds, and/or herbs.

In one embodiment, the first and second handles are attached to the flexible outer container using a transparent adhesive material. In one embodiment, each handle includes an elongated strip of material having a first end secured to the flexible outer container, an opposite second end secured to the flexible outer container, and a single twist formed in the elongated strip of material that is located between the first and second ends thereof.

In one embodiment, the package including the plant, the tray, and the flexible outer container is inserted into a shipping container with additional packages being abutted against two or more side panels of the flexible outer container.

In one embodiment, a package for a living, edible plant preferably includes a tray having a bottom wall and four side walls extending upwardly from the bottom wall to define an open, upper end of the tray, a living, edible plant being potted in soil in the tray, the plant including two or more different types of leaves for two or more different types of lettuce that extend above the open, upper end of the tray and outside an outer perimeter of the tray, and a flexible, transparent outer container having a bottom panel extending along a closed lower end of the flexible outer container and side panels extending upwardly from the bottom panel toward an open upper end of the flexible outer container.

In one embodiment, the tray and the living, edible plant are disposed inside the flexible, transparent outer container so that the bottom wall of the tray reinforces the bottom panel of the flexible, transparent outer container and the side walls of the tray oppose the side panels of the flexible, transparent outer container. In one embodiment, the tray is more rigid than the bottom panel and the side panels of the flexible, transparent outer container. In one embodiment, the upper ends of the side panels of the flexible, transparent outer container extend above upper ends of the four side walls of the tray. In one embodiment, the upper ends of the leaves of the plant extend above the upper ends of the side panels of the flexible, transparent outer container, and the upper ends of the side panels of the flexible, transparent outer container engage the leaves of the plant for tucking the leaves inwardly.

In one embodiment, first and second handles are attached to the side panels of the flexible, transparent outer container.

In one embodiment, the tray has a length of about 6-7 inches, a width of about 4-5 inches and a height of about 2 inches. In one embodiment, the flexible, transparent outer container has a length of about 7-9 inches, a width of about 5-7 inches and a height of about 7 inches.

In one embodiment, prior to being disposed inside the flexible, transparent outer container, the leaves of the plant define a length of about 12-14 inches, a width of about 8-9 inches, and a height of about 8-10 inches.

In one embodiment, the first and second handles are attached to the flexible outer container using a transparent adhesive material. In one embodiment, each handle preferably includes an elongated strip of material having a first end secured to the flexible outer container, an opposite second end secured to the flexible outer container, and a single twist formed in the elongated strip of material that is located between the first and second ends thereof.

In one embodiment, a method of packaging a living, edible plant desirably includes providing a tray having a bottom wall and four side walls extending upwardly from the bottom wall to define an open, upper end of the tray, placing soil inside the tray and planting a living, edible plant in the soil, and growing the living, edible plant until the plant is fully grown and has leaves. In one embodiment, the leaves of the fully grown plant define a plant length of about 12-14 inches, a plant width of about 8-9 inches and a plant height of about 8-10 inches.

In one embodiment, the method includes providing a flexible outer container having a bottom panel extending along a closed lower end of the flexible outer container and side panels extending upwardly from the bottom panel toward an open upper end of the flexible outer container. In one embodiment, the bottom panel of the flexible outer container has a length of about 8 inches and a width of about 6 inches, and the side panels of the flexible outer container have a height of about 7 inches.

In one embodiment, the method includes inserting the tray and the fully grown living, edible plant inside the flexible outer container so that the bottom wall of the tray engages the bottom panel of the flexible outer container with upper ends of the leaves extending above the upper ends of the side panels of the flexible outer container. In one embodiment, as the tray is inserted into the flexible outer container, the upper ends of the side panels of the flexible outer container engage the leaves of the plant for tucking the leaves inwardly.

In one embodiment, a method preferably includes attaching a first handle to a first one of the side panels of the flexible outer container, and attaching a second handle to a second one of the side panels of the flexible outer container.

In one embodiment, the flexible outer container is transparent. In one embodiment, each of the first and second handles has ends attached to the flexible outer container, whereby the ends of the handles are transparent.

### BRIEF DESCRIPTION OF THE DRAWING

FIG. 1 shows all the stages of growth and packaging a living, edible plant, in accordance with one embodiment.

FIG. 2A shows the first and second stages of growing the living, edible plant of FIG. 1.

FIG. 2B shows the third and fourth stages of growing a living, edible plant of FIG. 1.

FIG. 2C shows the fifth and sixth stages of growing the living, edible plant of FIG. 1.

FIGS. 3A-3D show a package for a living, edible plant, in accordance with one embodiment.

FIG. 4 shows a package for a living, edible plant, in accordance with one embodiment.

FIG. 5 shows a method of shipping a plurality of the packages shown in FIG. 4.

FIGS. 6A-6C show a package for a living, edible plant, in accordance with another embodiment.

FIGS. 7A-7D show a package for a living, edible plant, in accordance with another embodiment

### DETAILED DESCRIPTION OF PREFERRED EMBODIMENTS

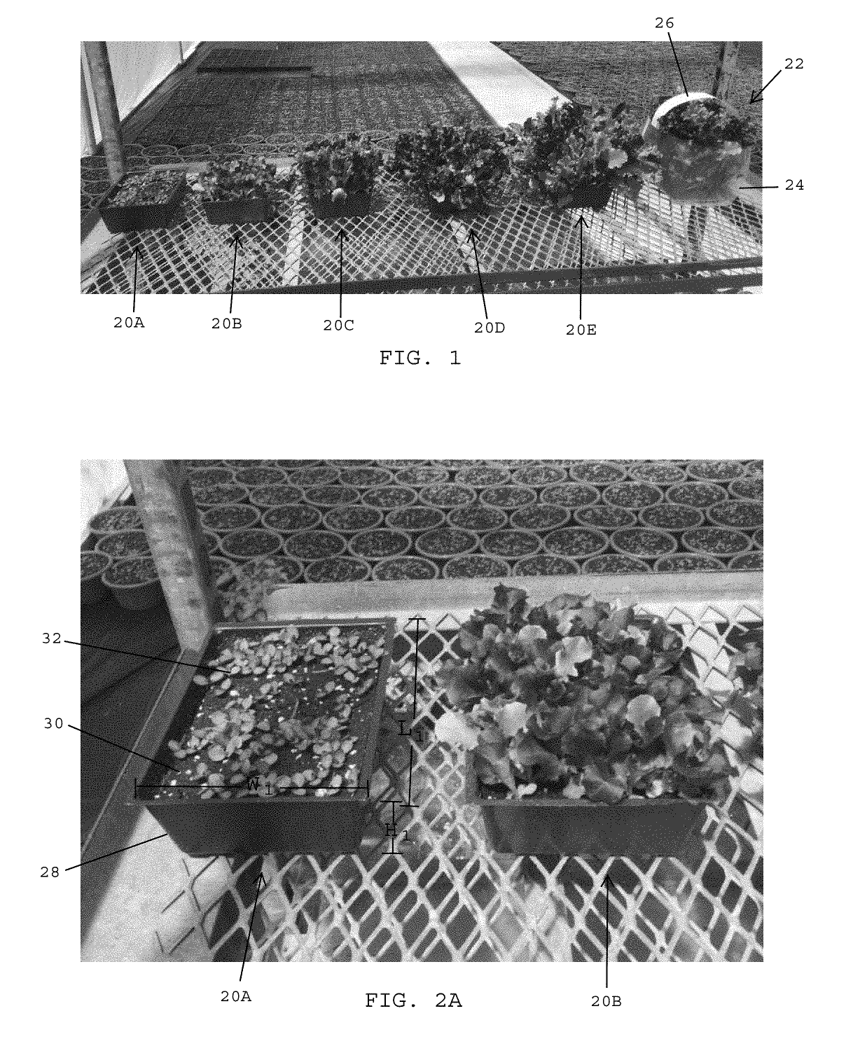

Referring to FIG. 1, in one embodiment, a living, edible plant is grown through various stages until it is fully grown. Once fully grown, the living, edible plant is placed into a clear or transparent display package for transport to a commercial establishment, such as a farmer's market or supermarket. In one embodiment, the living, edible plant 20 has five stages of growth designated 20A-20E before the fully grown plant 20E is placed inside the transparent package 22. In one embodiment, the package 22 has a flexible, transparent, plastic outer container 24 and a handle 26 attached to the outer container 24. In one embodiment, the handle 26 is separately formed from the clear, plastic outer container 24 and is attached to the sides of the outer container 24.

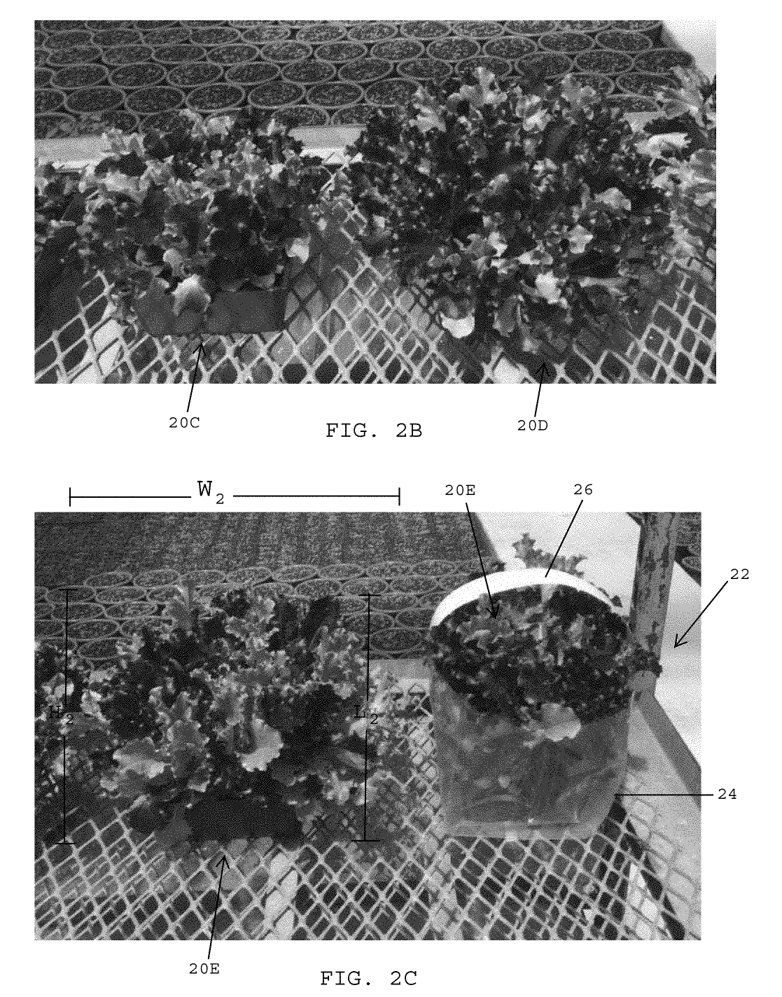

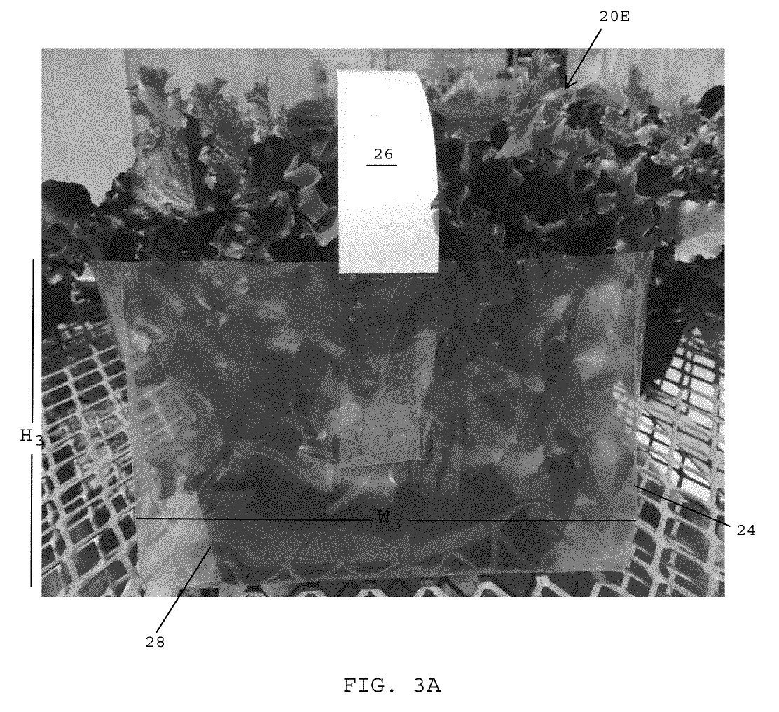

Referring to FIG. 2A, in one embodiment, a living, edible plant 20A is grown by providing a tray 28 having a length L₁ of about 5-8 inches and more preferably about 6.50 inches, a width W₁ of about 4-6 inches and more preferably about 4.5 inches, and a height H₁ of about 1-3 inches and more preferably about 2.0 inches. Soil 30 is placed into the tray 28, and seeds are planted in the soil 30. The seeds are watered to grow seedlings 32. FIG. 2A shows the living, edible plant 20B during a second growing stage.

FIG. 2B shows the living, edible plant during a third growth stage 20C and a fourth growth stage 20D. FIG. 2C shows the living, edible plant during a fifth growth stage 20E upon which the plant is deemed to be fully grown and ready for shipment to a commercial establishment. In one embodiment, the fully grown plant 20E has a length L₂ of about 12-14 inches, a width W₂ of about 8-9 inches, and a height H₂ of about 8-10 inches. FIG. 2C shows the fully grown live, edible plant 20E placed into the transparent display package 22 having a transparent outer container 24 and a handle 26 attached to the transparent outer container.

In one embodiment, a living, edible plant may be grown using a plurality of different lettuce seeds and/or herb seeds provided in various combinations. In one embodiment, seed packets are used whereby each seed packet contains a different type of seed. In one embodiment, the first seed packet contains green leaf lettuce seeds, the second seed packet contains red leaf lettuce seeds, the third seed packet contains red oak leaf lettuce seeds, the fourth seed packet contains Bibb lettuce seeds, the fifth seed packet contains green oak leaf lettuce seeds, the sixth seed packet contains Jericho lettuce seeds, and the seventh seed packet contains outrageous red Romaine lettuce seeds. In one embodiment, seven seed packets for seven different types of lettuce are used, however, other plants may use more or less types of seeds, whereby each type of seed packet contains a different type of seed. A living, edible plant may also include herbs. In one embodiment, a living, edible plant includes red lettuce leaves such as those disclosed in U.S. patent application Ser. No. 13/901,804, assigned to Rutgers University, located in New Brunswick, N.J..

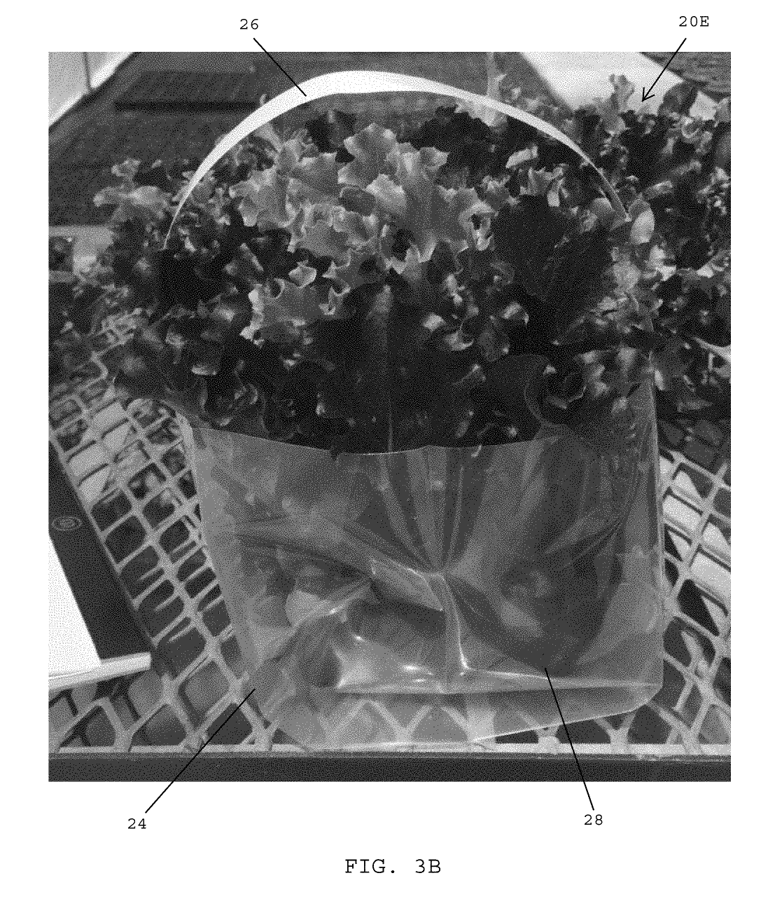

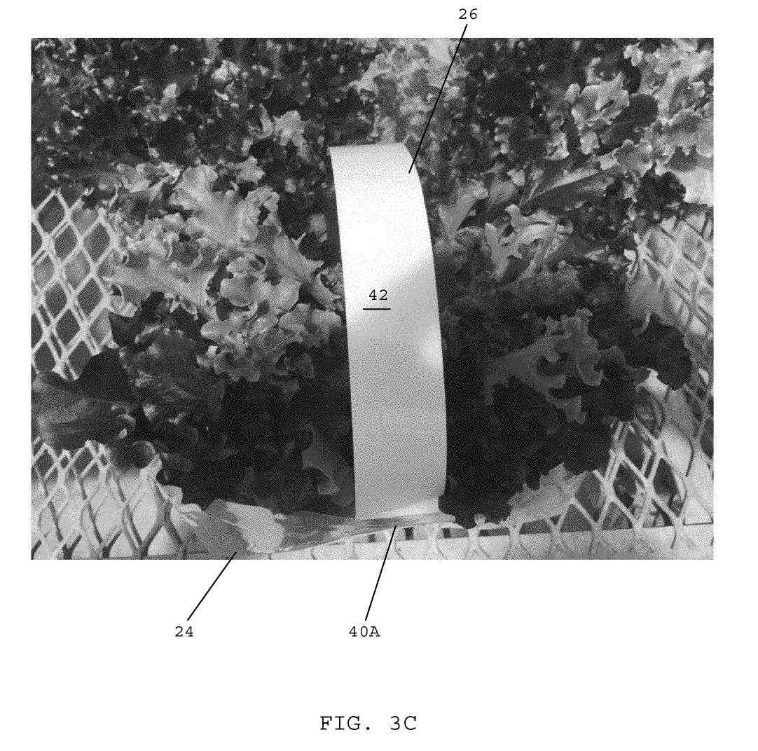

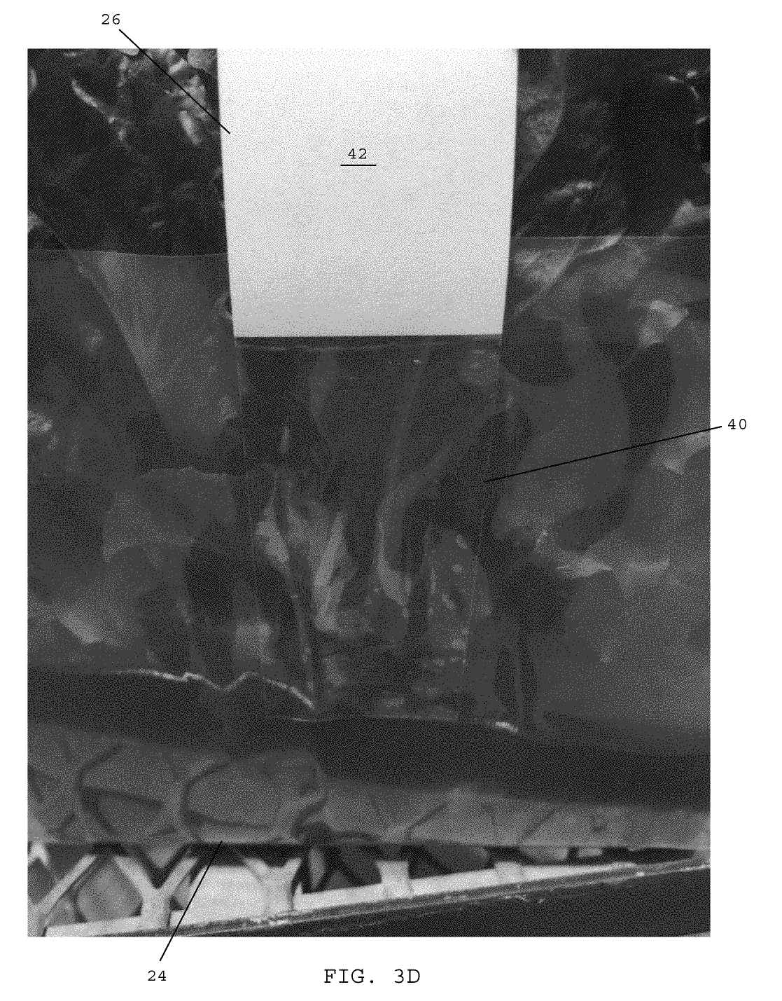

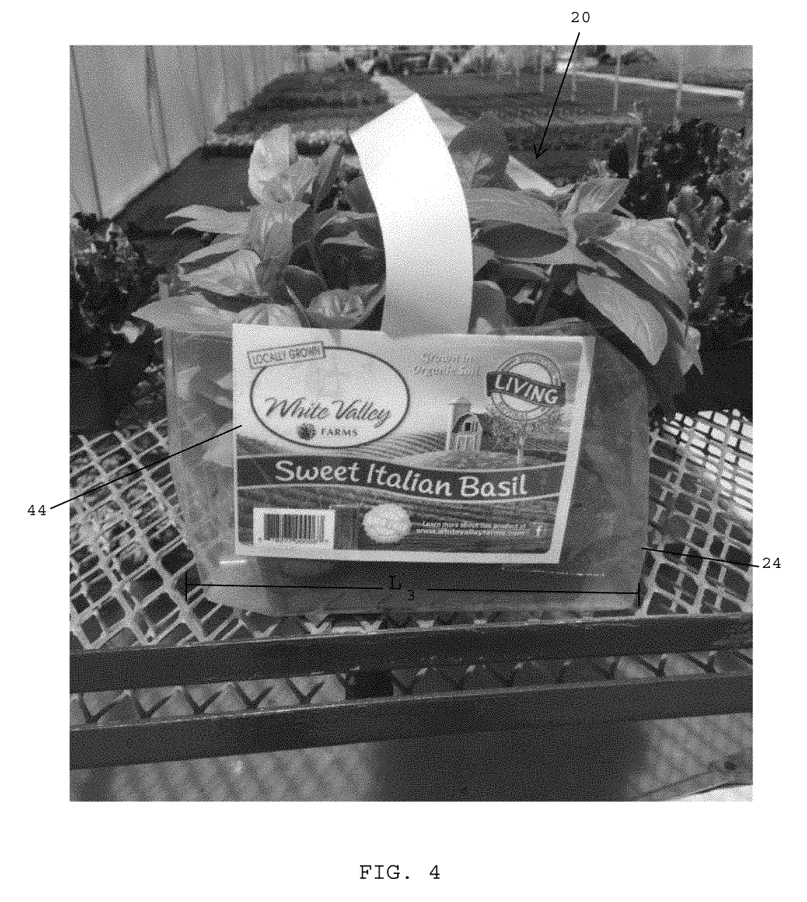

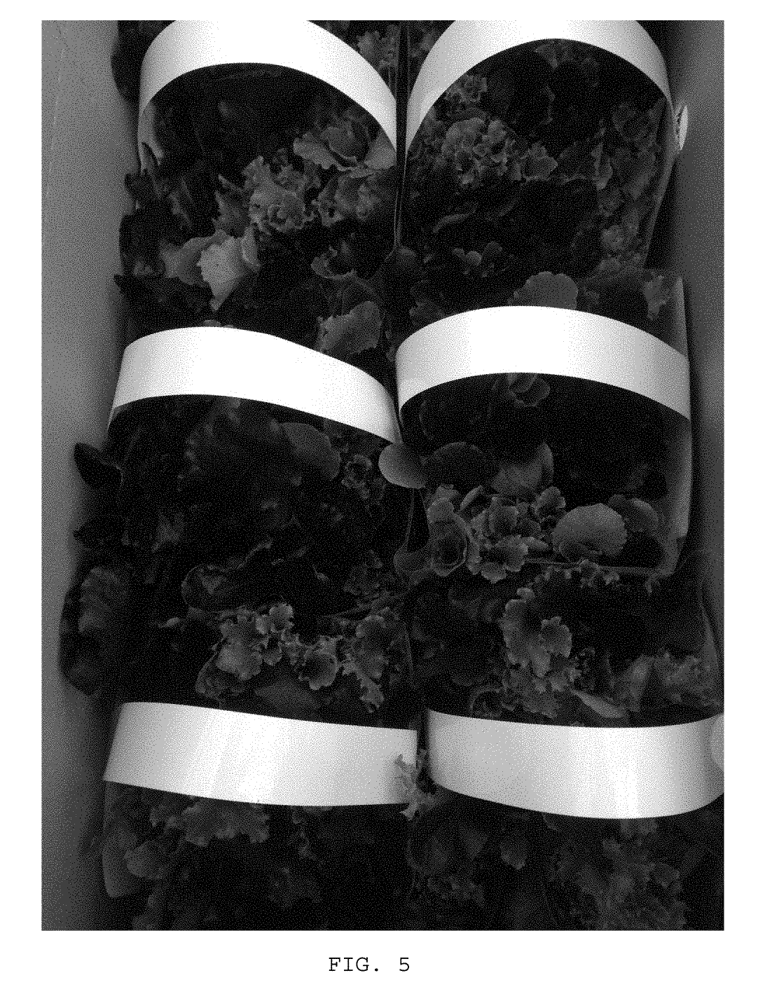

Referring to FIGS. 3A-3D, in one embodiment, the tray 28 containing the fully grown, live, edible plant 20E is placed inside the transparent, flexible, plastic outer container 24. In one embodiment, the transparent outer container 24 has a closed bottom wall having a length L₃ (FIG. 4) of about 7-9 inches and more preferably 8 inches, and a width W₃ of about 5-7 inches and more preferably about 6 inches, and four side walls having a height H₃ of about 6-8 inches and more preferably about 7 inches that extend upwardly from the closed, bottom wall. The transparent outer container 24 is open at the upper ends of the four side walls. The opening at the upper end is large enough to pass the tray 28 through the opening. When the plant 20E is positioned inside the outer container 24 and supported by the bottom wall of the outer container, the leaves of the plant preferably extend above and outside the four side walls of the outer container. In one embodiment, after the fully grown plant 20E is positioned inside the outer container, the handle 26 is attached to two opposing side walls of the outer container. In one embodiment, a first end of the handle 26 is attached to a first side wall of the outer container and a second end of the handle is attached to an opposite, second side wall of the outer container. In one embodiment, the first and second ends of the handle that are attached to the opposing side walls of the outer container are transparent (so that the plant can be seen through the handle ends) and a center section of the handle 26 is opaque (e.g., white) so that it can be readily seen and identified as the grasping portion of the handle.

Referring to FIGS. 3C and 3D, in one embodiment, the handle 26 has the transparent ends 40A, 40B that are attached to the transparent side walls of the outer container 24, and an opaque, center section 42 that extends between the side walls and over the top of the plant 20E. The attachment of the transparent ends 20A, 40B of the handle 26 to the side walls may be made using an adhesive material.

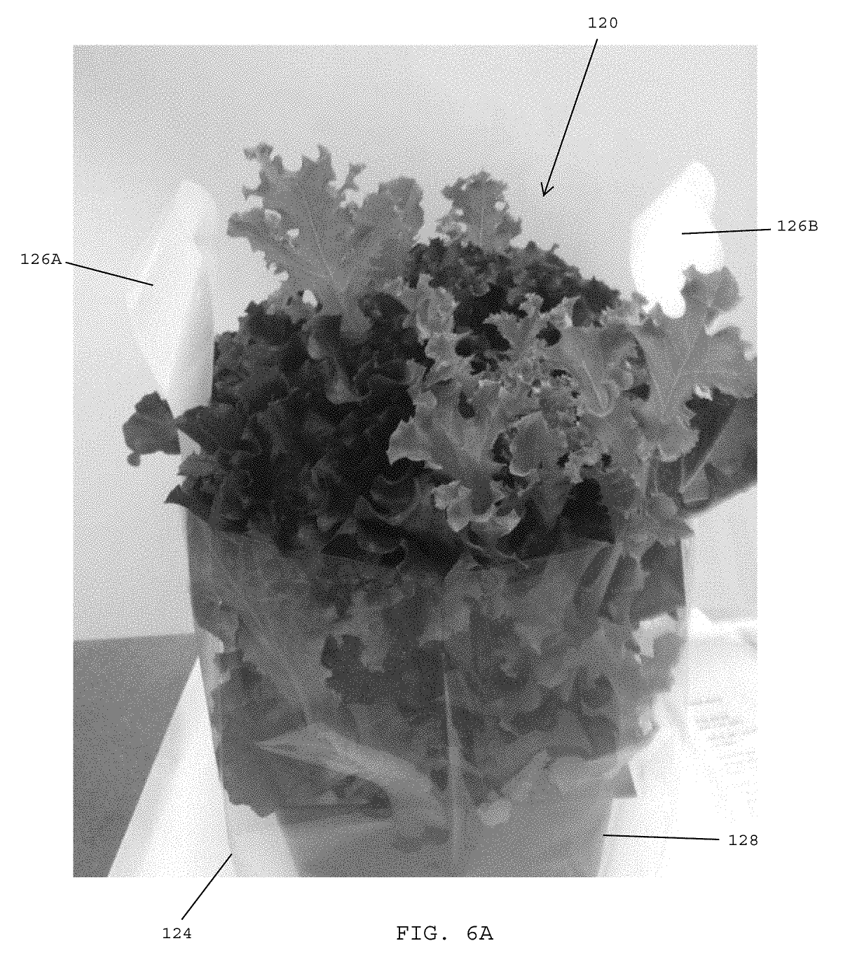

Referring to FIG. 4, in one embodiment, a label 44 may be positioned on one of the side walls of the transparent outer container 24. The label 44 may provide information about the living, edible plant 20. The label 44 may be placed inside the side wall or outside the side wall. FIG. 5 shows a plurality of living, edible plants that are placed into packages having handles and that are ready for shipment to a retail establishment.

In one embodiment, the plant packages are placed on store shelves with the labels facing the aisles (i.e., toward the customers). A customer may observe the plant including the outer container and the leaves through the transparent side walls of the transparent outer container. A customer may pick up a package using the handle for transferring the package into a shopping cart or to a checkout counter.

In one embodiment, a living, edible plant is transported to a customer's home, where it may be placed intact on a windowsill. The customer will pick the leaves accessible at the opening of the outer container when desired for use when cooking and/or eating. The customer may water the plant to continue to grow the leaves between the times that the leaves are picked. The leaves are still alive when they are picked to provide a customer with extremely fresh food.

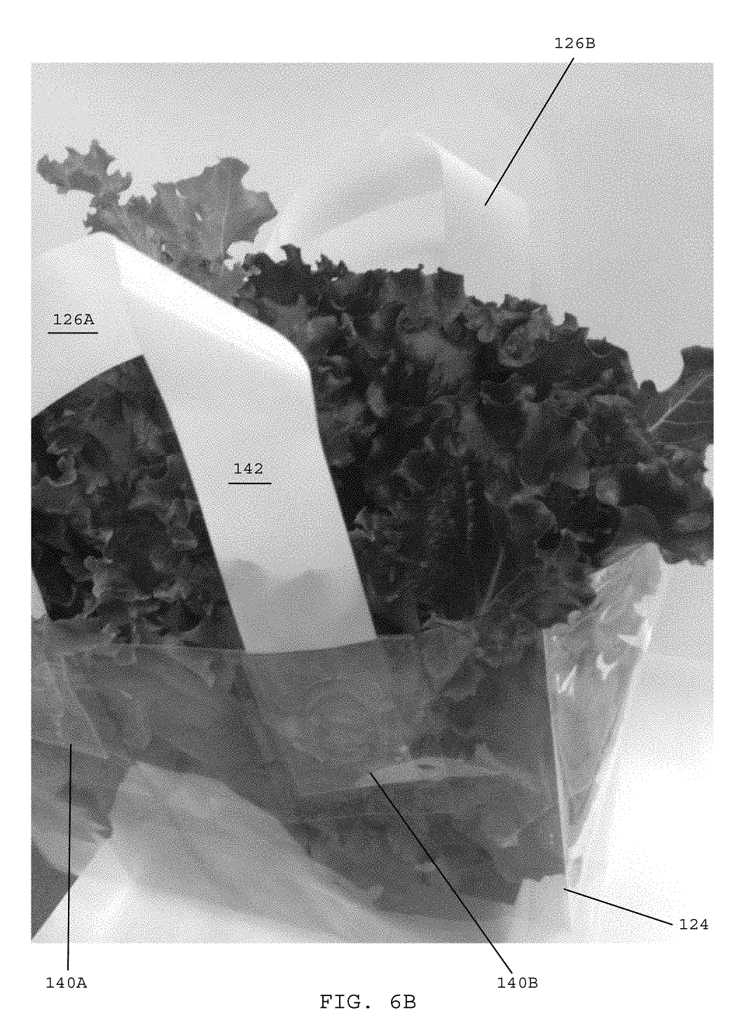

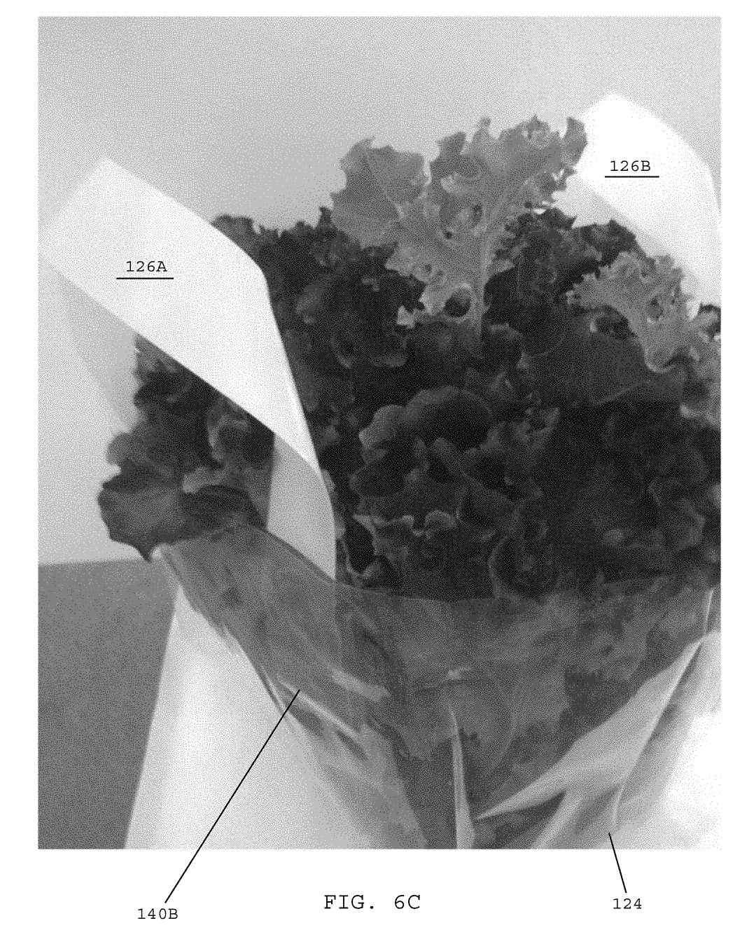

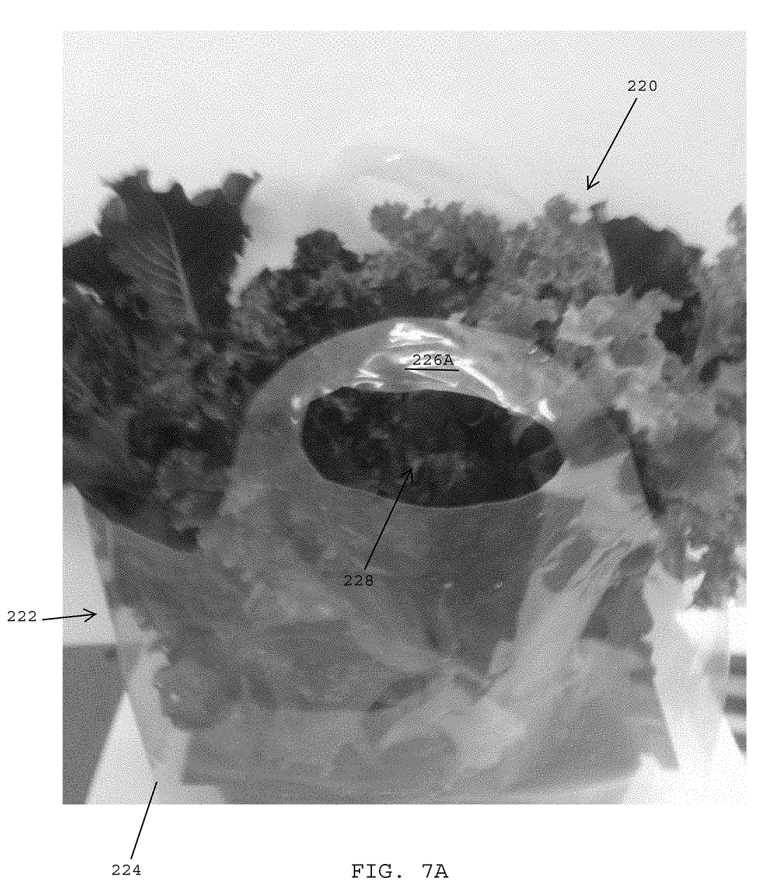

Referring to FIGS. 6A-6C, in one embodiment a living, edible plant 120 has two handles 126A, 126B that are attached to the upper ends of opposing side wall of a transparent outer container 124, which, in turn, holds a tray 128, soil in the tray, and leaves growing up from the soil. Referring to FIG. 6B, the first handle 126A has first and second transparent ends 140A, 140B that are attached to a first, transparent side wall of the outer container 124. The transparent ends allow the plant to be seen by a customer. An opaque, center section 142 of the first handle 126A extends between the transparent ends 140A, 140B. In one embodiment, a center section 142 of the first handle 126A has a twist, which provides a broad section of the first handle for being grasped by a customer. The second handle 126B is connected to an opposite, second side wall of the outer container 124. In one embodiment, the second handle 126B has the same structure including the twist as the first handle 126A.

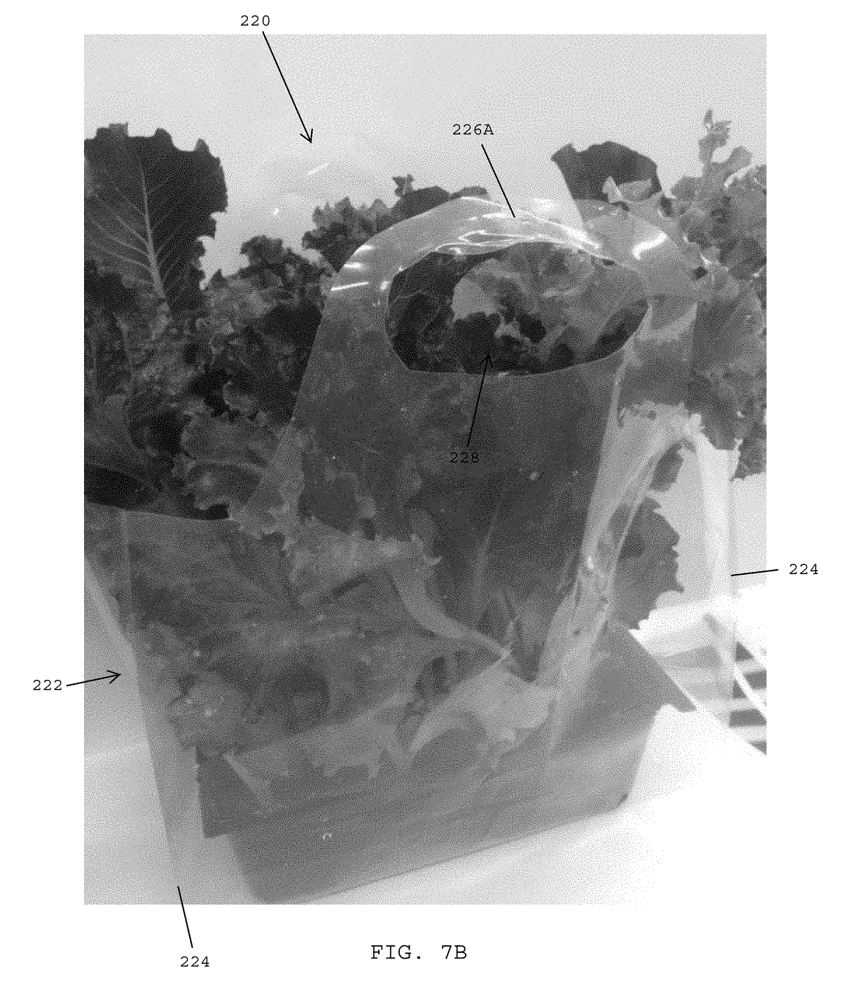

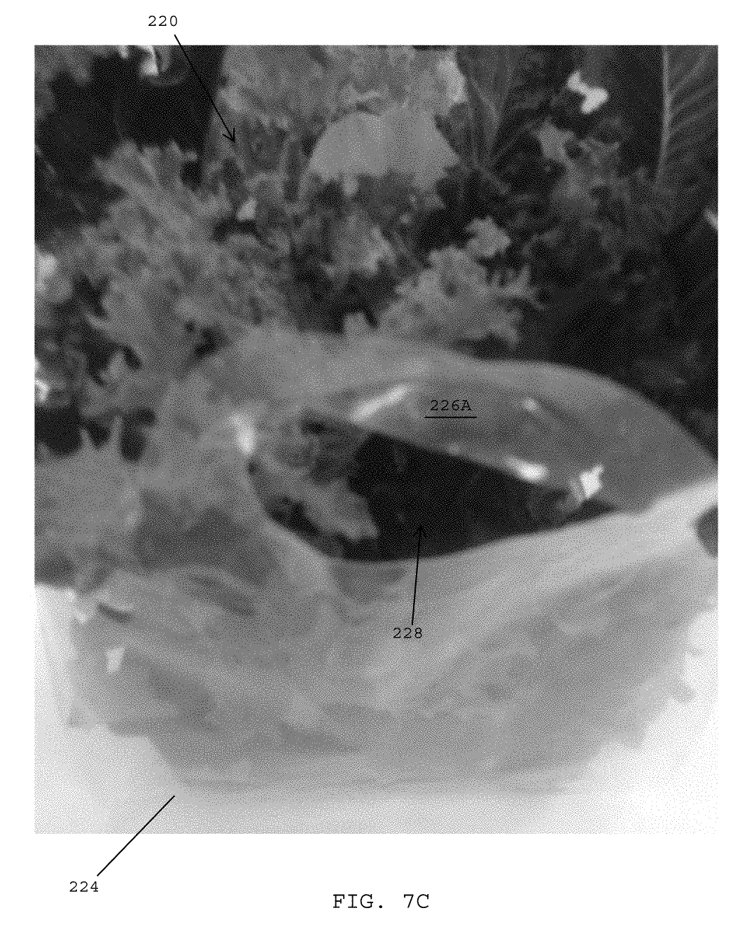

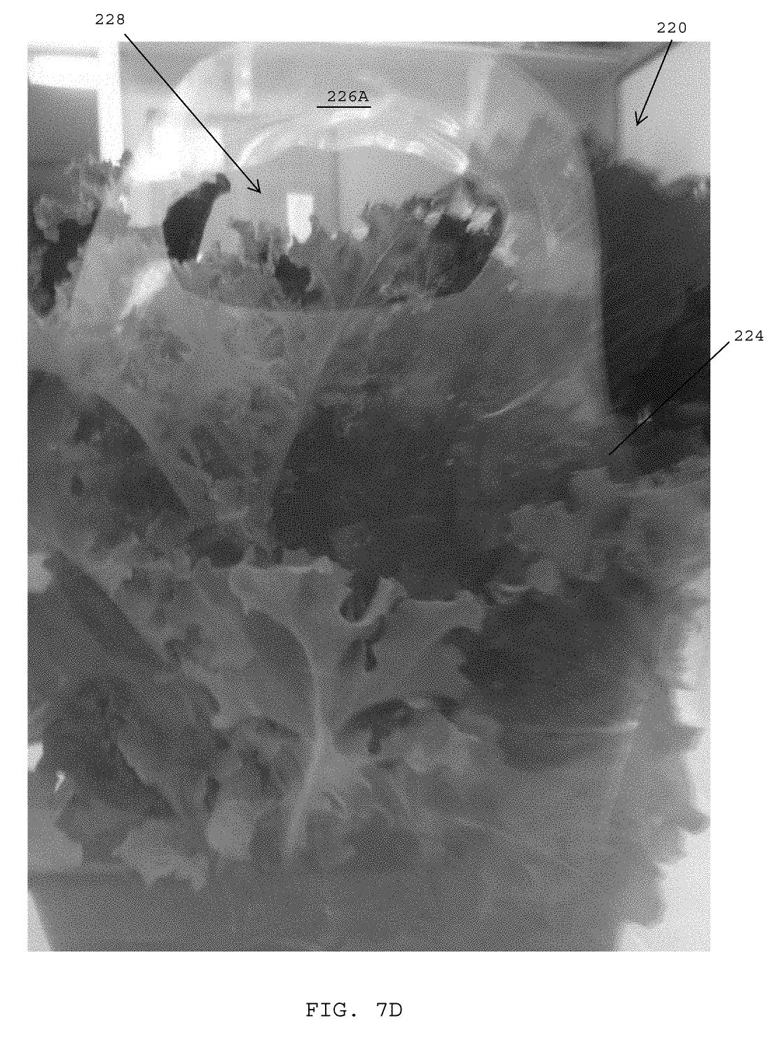

Referring to FIGS. 7A-7D, in one embodiment, a living, edible plant 220 is placed into a transparent package 222 having a transparent, flexible, plastic outer container 224. The plant 220 has one or more of the features disclosed above. The outer container 224 preferably has a closed, bottom wall and four transparent, opposing side walls. Two opposing side walls of the outer container 224 have respective first and second transparent handles 226A, 226B that are integrally formed with the upper ends of the respective first and second transparent side walls. The transparent handles have openings 228 that enable a customer to place his or her fingers through the openings to pick up the plant 220 using the handles 226A, 226B for transport into a cart or a checkout counter.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

What is claimed is:

1. A package for a living, edible plant comprising:
a tray having a bottom wall and four side walls extending upwardly from said bottom wall to define an open, upper end of said tray;
a living, edible plant being potted in soil in said tray, said plant including leaves that extend above said open, upper end of said tray and outside an outer perimeter of said tray;
a flexible outer container having a bottom panel extending along a closed lower end of said flexible outer container and side panels extending upwardly from said bottom panel toward an open upper end of said flexible outer container;
said tray and said living, edible plant being disposed inside said flexible outer container so that said bottom wall of said tray reinforces said bottom panel of said flexible outer container and said side walls of said tray oppose said side panels of said flexible outer container, wherein said tray is more rigid than said bottom panel and said side panels of said flexible outer container, wherein upper ends of said side panels of said flexible outer container extend above upper ends of said four side walls of said tray, wherein upper ends of said leaves extend above said upper ends of said side panels of said flexible outer container, and wherein said upper ends of said side panels of said flexible outer container engage said leaves for tucking said leaves inwardly inside said flexible outer container;
a first handle attached to a first one of said side panels of said flexible outer container;
a second handle attached to a second one of said side panels of said flexible outer container.

2. The package as claimed in claim 1, wherein said flexible outer container is transparent.

3. The package as claimed in claim 1, wherein said tray has a length of about 6-7 inches, a width of about 4-5 inches and a height of about 2 inches.

4. The package as claimed in claim 3, wherein said flexible outer container has a length of about 7-9 inches, a width of about 5-7 inches and a height of about 7 inches.

5. The package as claimed in claim 4, wherein prior to being disposed inside said flexible outer container, said plant has a length of about 12-14 inches, a width of about 8-9 inches, and a height of about 8-10 inches.

6. The package as claimed in claim 1, wherein said plant comprises two or more different types of leaves for two or more different types of lettuce.

7. The package as claimed in claim 6, wherein said plant comprises five or more different types of leaves for five or more different types of lettuce.

8. The package as claimed in claim 7, wherein said five or more different types of lettuce are selected from the group consisting of green leaf lettuce, red leaf lettuce, red oak leaf lettuce, Bibb lettuce, green oak leaf lettuce, Jericho lettuce, red Romaine lettuce seeds, and herbs.

9. The package as claimed in claim 1, wherein said first and second handles are attached to said flexible outer container using a transparent adhesive material.

10. The package as claimed in claim 1, wherein each said handle comprises an elongated strip of material having a first end secured to said flexible outer container, an opposite second end secured to said flexible outer container, and a single twist formed in said elongated strip of material that is located between said first and second ends thereof.

11. The package as claimed in claim 1, wherein said package is inserted into a shipping container with additional packages abutted against two or more side panels of said flexible outer container.

12. A package for a living, edible plant comprising:
a tray having a bottom wall and four side walls extending upwardly from said bottom wall to define an open, upper end of said tray;
a living, edible plant being potted in soil in said tray, said plant including two or more different types of leaves for two or more different types of lettuce that extend above said open, upper end of said tray and outside an outer perimeter of said tray;
a flexible, transparent outer container having a bottom panel extending along a closed lower end of said flexible outer container and side panels extending upwardly from said bottom panel toward an open upper end of said flexible outer container;
said tray and said living, edible plant being disposed inside said flexible, transparent outer container so that said bottom wall of said tray reinforces said bottom panel of said flexible, transparent outer container and said side walls of said tray oppose said side panels of said flexible, transparent outer container, wherein said tray is more rigid than said bottom panel and said side panels of said flexible, transparent outer container, wherein upper ends of said side panels of said flexible, transparent outer container extend above upper ends of said four side walls of said tray, wherein upper ends of leaves extend above said upper ends of said side panels of said flexible, transparent outer container, and wherein said upper ends of said side panels of said flexible, transparent outer container engage said leaves of said plant for tucking said leaves inwardly, and;
first and second handles attached to said side panels of said flexible, transparent outer container.

13. The package as claimed in claim 12, wherein said tray has a length of about 6-7 inches, a width of about 4-5 inches and a height of about 2 inches, and wherein said flexible, transparent outer container has a length of about 7-9 inches, a width of about 5-7 inches and a height of about 7 inches.

14. The package as claimed in claim 13, wherein prior to being disposed inside said flexible, transparent outer container, said leaves of said plant define a length of about 12-14 inches, a width of about 8-9 inches, and a height of about 8-10 inches.

15. The package as claimed in claim 12, wherein said two or more different types of leaves for two or more different types of lettuce are selected from the group consisting of green leaf lettuce, red leaf lettuce, red oak leaf lettuce, Bibb lettuce, green oak leaf lettuce, Jericho lettuce, red Romaine lettuce seeds, and herbs.

16. The package as claimed in claim 12, wherein said first and second handles are attached to said flexible outer container using a transparent adhesive material, and wherein each said handle comprises an elongated strip of material having a first end secured to said flexible outer container, an opposite second end secured to said flexible outer container, and a single twist formed in said elongated strip of material that is located between said first and second ends thereof.

17. A method of packaging a living, edible plant comprising:
providing a tray having a bottom wall and four side walls extending upwardly from said bottom wall to define an open, upper end of said tray;
placing soil inside said tray and planting a living, edible plant in said soil;
growing said living, edible plant until said plant is fully grown and has leaves, wherein said leaves of said fully grown plant define a plant length of about 12-14 inches, a plant width of about 8-9 inches and a plant height of about 8-10 inches;
providing a flexible outer container having a bottom panel extending along a closed lower end of said flexible outer container and side panels extending upwardly from said bottom panel toward an open upper end of said flexible outer container, wherein said bottom panel has a length of about 8 inches and a width of about 6 inches, and wherein said side panels of said flexible outer container have a height of about 7 inches;
inserting said tray and said fully grown living, edible plant inside said flexible outer container so that said bottom wall of said tray engages said bottom panel of said flexible outer container with upper ends of said leaves extending above said upper ends of said side panels of said flexible outer container, wherein as said tray is inserted into said flexible outer container, said upper ends of said side panels of said flexible outer container engage said leaves of said plant for tucking said leaves inwardly.

18. The method as claimed in claim 17, further comprising:
attaching a first handle to a first one of said side panels of said flexible outer container;
attaching a second handle to a second one of said side panels of said flexible outer container.

19. The method as claimed in claim 17, wherein said flexible outer container is transparent, and wherein each of said first and second handles have ends attached to said flexible outer container that are transparent.

20. The method as claimed in claim 17, wherein said tray has a length of about 6-7 inches, a width of about 4-5 inches and a height of about 2 inches.
